(19) United States
(12) Patent Application Publication
(10) Pub. No.: US 2026/0087311 A1
(43) Pub. Date: Mar. 26, 2026

(54) CONTROLLING AGENTS USING AMBIGUITY-SENSITIVE NEURAL NETWORKS AND RISK-SENSITIVE NEURAL NETWORKS

(71) Applicant: DeepMind Technologies Limited, London (GB)

(72) Inventors: Jordi Grau Moya, Cambridge (GB); Gregoire Deletang, London (GB); Markus Kunesch, London (GB); Pedro Alejandro Ortega Caballero, London (GB)

(21) Appl. No.: 19/109,963

(22) PCT Filed: Sep. 8, 2023
(86) PCT No.: PCT/EP2023/074759

§ 371 Date: Mar. 7, 2025

Related U.S. Application Data
(60) Provisional application No. 63/404,917, filed on Sep. 8, 2022.

(51) Int. Cl. G06N 3/045; G06N 3/08

(52) U.S. Cl. CPC G06N 3/045; G06N 3/08

(57) ABSTRACT

Methods, systems, and apparatus, including computer programs encoded on a computer storage medium, for controlling agents. In particular, an agent can be controlled using an action selection system that is risk-sensitive, ambiguity-sensitive, or both.

### CROSS-REFERENCE TO RELATED APPLICATION

This application claims priority to U.S. Provisional Application No. 63/404,917, filed on Sep. 8, 2022. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that controls an agent interacting with an environment to perform a task in the environment using a set of one or more neural networks.

Generally, the system controls the agent using a set of one or more neural networks that are “ambiguity-sensitive” (also referred to as “ambiguity-aware”), “risk-sensitive” (also referred to as “risk-aware”), or both.

A neural network is “ambiguity-sensitive” when the outputs generated by the neural network depend on whether the neural network estimates that the impact of taking one or more of the actions in a given state is ambiguous, e.g., that the neural network does not have enough information to accurately estimate the expected return that will result from taking a given action in a given state. For example, the action selection neural network can be “ambiguity-seeking” and act optimistically when faced with an ambiguous state or “ambiguity-averse” and act pessimistically when faced with an ambiguous state.

A “risk-sensitive” action selection neural network is one that generates action selection outputs that are dependent on whether the action is likely to be a risky action given the current state of the environment. An action is “risky” if the expected returns resulting from selecting the action are associated with a relatively high degree of variance or other higher-order moment, i.e., relative to the other actions in the set. For example, the action selection neural network can be “risk-seeking” and more likely to select risky actions or “risk-averse” and less likely to select risky actions.

In one aspect, a method includes obtaining an observation; processing the observation using each action selection neural network in an ensemble of multiple action selection neural networks, each action selection neural network in the ensemble being configured to process an action selection input comprising the observation to generate a respective action selection output that defines a respective action selection policy for selecting an action from a set of actions in response to the observation; generating a meta-policy input from the respective action selection outputs generated by each of the action selection neural networks in the ensemble; processing the meta-policy input using a meta-policy neural network to generate a meta-policy output that defines a meta-policy for selecting an action from the set of actions in response to the observation; selecting an action from the set of actions using the meta-policy output; and causing the agent to perform the selected action.

In some implementations, the meta-policy input does not include the observation.

In some implementations, the respective action selection outputs each include a respective score for each action in the set of actions.

In some implementations, the respective scores are Q-values.

In some implementations, generating a meta-policy input from the respective action selection outputs generated by each of the action selection neural networks in the ensemble comprises: concatenating the respective scores for each of the actions in each of the respective action selection outputs.

In some implementations, generating a meta-policy input from the respective action selection outputs generated by each of the action selection neural networks in the ensemble comprises: for each action: computing one or more moments of the respective scores for the action in the respective action selection outputs; and including the one or more moments in the meta-policy input.

In some implementations, the one or more moments comprise a first moment and a second moment of the respective scores for the action in the respective action selection outputs.

In some implementations, the meta-policy input includes only the one or more moments for each of the actions.

In some implementations, the meta-policy neural network comprises: a torso neural network configured to process the meta-policy input to generate an encoded representation; a recurrent neural network configured to process the encoded representation and a current internal state to generate an updated internal state; and a policy head neural network configured to process the updated internal state to generate the meta-policy output.

In some implementations, the meta-policy neural network has been trained on first training data that includes (i) ambiguous training examples and (ii) non-ambiguous training examples.

In some implementations, the action selection neural networks in the ensemble have been trained on second training data that includes only non-ambiguous training examples.

In some implementations, the agent is a mechanical agent and the environment is a real-world environment.

In some implementations, the agent is a robot.

In some implementations, the environment is a real-world environment of a service facility comprising a plurality of items of electronic equipment and the agent is an electronic agent configured to control operation of the service facility.

In some implementations, the environment is a real-world manufacturing environment for manufacturing a product and the agent comprises an electronic agent configured to control a manufacturing unit or a machine that operates to manufacture the product.

In some implementations, during training, the environment is a simulated environment and the agent is a simulated agent.

In some implementations, the ensemble and the meta-policy neural network for use in controlling a real-world agent interacting with a real-world environment.

In some implementations, the method further comprises after the training, controlling a real-world agent interacting with a real-world environment using the ensemble and the meta-policy neural network.

In another aspect, this specification describes generating training data for training an action selection neural network to be risk-sensitive. In this aspect, a method for generating a training example to be included in the training data for training the action selection neural network, includes identifying a current action performed by the agent in response to a current observation characterizing a current state of the environment; identifying a plurality of candidate next states that the environment transitions into as a result of the agent performing the current action in response to the current observation; generating, using the neural network, a respective value estimate for each of the candidate next states and selects one of the candidate next states based on the respective value estimates; generating a training example that identifies (i) the current observation, (ii) the current action, and (iii) a next observation characterizing the selected candidate next states. In some implementations, the system also identifies a current reward that is received in response to the agent performing the current action and also includes the current reward in the training example.

After the training example is generated, the system can train the neural network on the generated training data that includes the training example through reinforcement learning.

In some implementations, the system can identify the current action by processing the current observation using the action selection neural network, using the action selection output to select the current action, and then causing the agent to perform the current action. In some other implementations, the system can identify the current action from an initial set of training data that has already been generated by controlling the agent.

In some implementations, when the action selection neural network is being trained in simulation, the system can identify the candidate next states by sampling a fixed number of candidate next states from the simulation, e.g., the system can cause the simulation to draw multiple samples from an underlying transition probability distribution over next states of the environment given the current state and the current action.

In some other implementations, when the system is analyzing an initial set of training data, the system can search the initial set of training data for training examples where performing the current action in response to the current observation resulted in the environment transitioning into a given state and use all of the resulting states as the candidate next states or use a threshold number of most frequently occurring resulting states as the candidate next states.

In some implementations, selecting one of the candidate next states can include generating, based on the respective value estimates, a respective probability for each candidate next states and selecting one of the candidate next states based on the respective probabilities. For example, the system can sample a candidate next state in accordance with the respective probabilities.

In some implementations, the system generates the probabilities such that respective probabilities for candidate next states that have higher value estimates are higher than respective probabilities for candidate next states that have lower value estimates. For example, the system can apply a softmax with a specified temperature over the respective value estimates to generate the respective probabilities. In some other implementations, the respective probabilities for candidate next states that have lower value estimates are higher than respective probabilities for candidate next states that have higher value estimates. For example, the system can apply a softmin with a specified temperature over the respective value estimates to generate the respective probabilities.

In some implementations, generating, using the neural network, a respective value estimate for each of the candidate next states can include: processing an input comprising an observation characterizing the candidate next state using the neural network to generate a respective Q value for each action in a set of actions; and selecting, as the respective value estimate for the candidate next state, a highest Q value of the respective Q values for the actions in the set.

Particular embodiments of the subject matter described in this specification can be implemented so as to realize one or more of the following advantages.

Some conventional approaches to reinforcement learning have been shown to culminate in Bayes-optimal agents. Bayes-optimal agents are risk-neutral, since they solely attune to the expected return, and ambiguity-neutral, since they act in new situations as if the uncertainty were known.

This is in contrast to risk-sensitive agents, which additionally exploit the higher-order moments of the return, and ambiguity-sensitive agents, which act differently when recognizing situations in which they lack knowledge.

In contrast to conventional approaches, this specification describes techniques for achieving agents that are risk-aware, ambiguity-aware, or both.

Many real-world tasks require the agent to be controlled in a risk-aware manner, an ambiguity-sensitive manner, or both.

For example, when the agent is a mechanical agent, actions that result in low returns can have negative consequences for the agent or for the environment, e.g., can cause wear and tear to the agent or can damage other objects in the environment. Thus, selecting an ambiguous action that has an unknown range of returns may need to be avoided (“ambiguity-averse”). Additionally, selecting a risky action that has a range of returns that can be accurately estimated but includes low returns may need to be avoided, even if other returns in the range are quite high (“risk-averse”).

As another example, when the agent is an electronic agent that controls a facility, actions that result in low returns can have negative consequences for the facility, e.g., can cause wear and tear to the facility or can prevent the facility from operating properly. Thus, selecting an ambiguous action that has an unknown range of returns may need to be avoided (“ambiguity-averse”). Additionally, selecting a risky action that has a range of returns that can be accurately estimated but includes low returns may need to be avoided, even if other returns in the range are quite high (“risk-averse”).

As another example, some real-world tasks may have few negative consequences for low-return actions and therefore prioritize achieving high returns. For example, pharmaceutical drug design may prioritize generating a successful candidate even if many unsuccessful ones are also produced. Thus, selecting an ambiguous action that has an unknown range of returns may be prioritized to maximize the likelihood that a high return is obtained (“ambiguity-seeking”). Additionally, selecting a risky action that has a range of returns that can be accurately estimated but includes high returns may need to be prioritized, even if other returns in the range are quite low (“risk-seeking”).

Thus, the techniques described in this specification can be used to effectively control agents to perform a variety of real-world tasks that require risk-sensitivity, ambiguity-sensitivity, or both.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2A is a flow diagram of an example process for selecting an action.

FIG. 2B shows an example action selection subsystem when the action selection subsystem is ambiguity-sensitive.

FIG. 3 is a flow diagram of an example process for training the ensemble of action selection neural networks and the meta-policy neural network.

FIG. 4 is a flow diagram of an example process for generating a training example for use in training an action selection neural network to become risk-sensitive.

Like reference numbers and designations in the various drawings indicate like elements.

### DETAILED DESCRIPTION

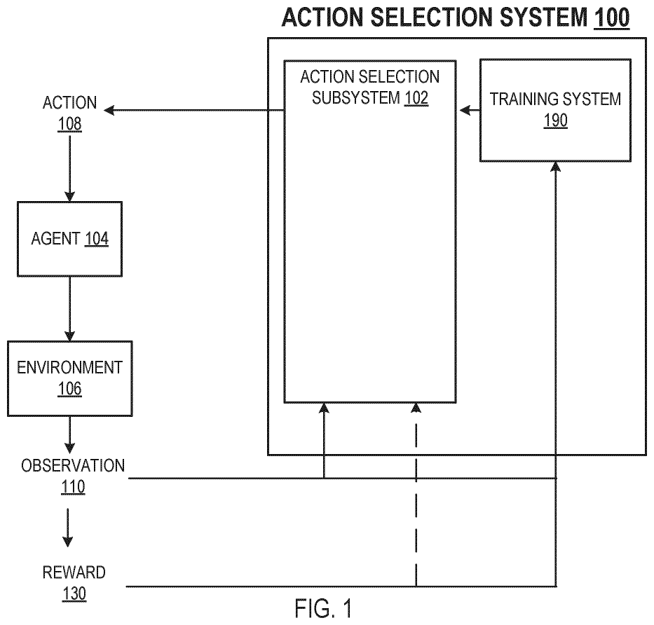

FIG. 1 shows an example action selection system 100. The action selection system 100 is an example of a system implemented as computer programs on one or more computers in one or more locations in which the systems, components, and techniques described below are implemented.

The action selection system 100 controls an agent 104 interacting with an environment 106 to accomplish a task by selecting actions 108 to be performed by the agent 104 at each of multiple time steps during the performance of an episode of the task.

As a general example, the task can include one or more of, e.g., navigating to a specified location in the environment, identifying a specific object in the environment, manipulating the specific object in a specified way, controlling items of equipment to satisfy criteria, distributing resources across devices, and so on. More generally, the task is specified by received rewards, i.e., such that an episodic return is maximized when the task is successfully completed. Rewards and returns will be described in more detail below. Examples of agents, tasks, and environments are also provided below.

An “episode” of a task is a sequence of interactions during which the agent attempts to perform a single instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

At each time step during any given task episode, the system 100 receives an observation 110 characterizing the current state of the environment 106 at the time step and, in response, selects an action 108 to be performed by the agent 104 at the time step. After the agent performs the action 108, the environment 106 transitions into a new state and the system 100 receives a reward 130 from the environment 106.

Generally, the reward 130 is a scalar numerical value and characterizes the progress of the agent 104 towards completing the task.

As a particular example, the reward 130 can be a sparse binary reward that is zero unless the task is successfully completed as a result of the action being performed, i.e., is only non-zero, e.g., equal to one, if the task is successfully completed as a result of the action performed.

As another particular example, the reward 130 can be a dense reward that measures a progress of the agent towards completing the task as of individual observations received during the episode of attempting to perform the task, i.e., so that non-zero rewards can be and frequently are received before the task is successfully completed.

While performing any given task episode, the system 100 selects actions in order to attempt to maximize a return that is received over the course of the task episode.

That is, at each time step during the episode, the system 100 selects actions that attempt to maximize the return that will be received for the remainder of the task episode starting from the time step.

Generally, at any given time step, the return that will be received is a combination of the rewards that will be received at time steps that are after the given time step in the episode.

For example, at a time step t, the return can satisfy:

$${Σ}_{i} {γ}^{i - t - 1} {r}_{i} ,$$

where i ranges either over all of the time steps after t in the episode or for some fixed number of time steps after t within the episode, γ is a discount factor that is greater than zero and less than or equal to one, and rᵢ is the reward at time step i.

To control the agent, at each time step in the episode, an action selection subsystem 102 of the system 100 uses a set of one or more neural networks to select the action 108 that will be performed by the agent 104 at the time step.

In some implementations, the action selection subsystem 102 is conditioned on not only the current observation but also a “memory” that includes the one or more earlier observations in the task episode. For example, the one or more neural networks can receive as input the earlier observation and the memory and can include, e.g., a self-attention layer that attends across the current observation and the memory. As another example, the one or more neural networks can include one or more recurrent layers so that the internal state of the recurrent layers conditions the one or more neural networks on the memory.

In particular, the action selection subsystem 102 uses the set of one or more neural networks to generate a policy output and then uses the policy output to select the action 108 to be performed by the agent 104 at the time step.

In one example, the policy output may include a respective numerical probability value for each action in a fixed set. The system 102 can select the action, e.g., by sampling an action in accordance with the probability values for the action indices, or by selecting the action with the highest probability value.

In another example, the policy output may include a respective Q-value for each action in the fixed set. The system 102 can process the Q-values (e.g., using a soft-max function) to generate a respective probability value for each action, which can be used to select the action (as described earlier), or can select the action with the highest Q-value.

The Q-value for an action is an estimate of a return that would result from the agent performing the action in response to the current observation and thereafter selecting future actions performed by the agent using future policy outputs generated using the action selection subsystem 102.

As another example, when the action space is continuous, the policy output can include parameters of a probability distribution over the continuous action space and the system 102 can select the action by sampling from the probability distribution or by selecting the mean action. A continuous action space is one that contains an uncountable number of actions, i.e., where each action is represented as a vector having one or more dimensions and, for each dimension, the action vector can take any value that is within the range for the dimension and the only constraint is the precision of the numerical format used by the system 100.

As yet another example, when the action space is continuous the policy output can include a regressed action, i.e., a regressed vector representing an action from the continuous space, and the system 102 can select the regressed action as the action 108.

In particular, the action selection subsystem selects the actions in a manner that is ambiguity-sensitive, risk-sensitive, or both.

The action selection subsystem is “ambiguity-sensitive” when the outputs generated by the action selection subsystem depend on whether the action selection subsystem estimates that the impact of taking one or more of the actions in a given state is ambiguous, e.g., that the action selection subsystem does not have enough information to accurately estimate the expected return that will result from taking a given action in a given state. For example, the action selection subsystem can be “ambiguity-seeking” and act optimistically when faced with an ambiguous state or “ambiguity-averse” and act pessimistically when faced with an ambiguous state.

When the action selection subsystem is ambiguity-sensitive, the action selection subsystem includes an ensemble of action selection neural networks that each generate a respective action selection output and a meta-policy neural network that receives an input generated from the action selection outputs and generates a “meta-policy” output that the action selection subsystem uses to select the action.

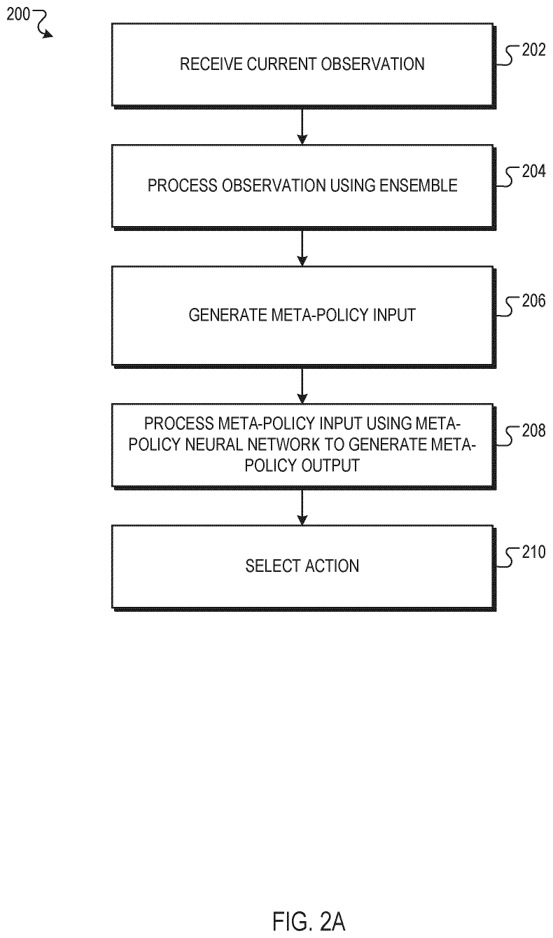

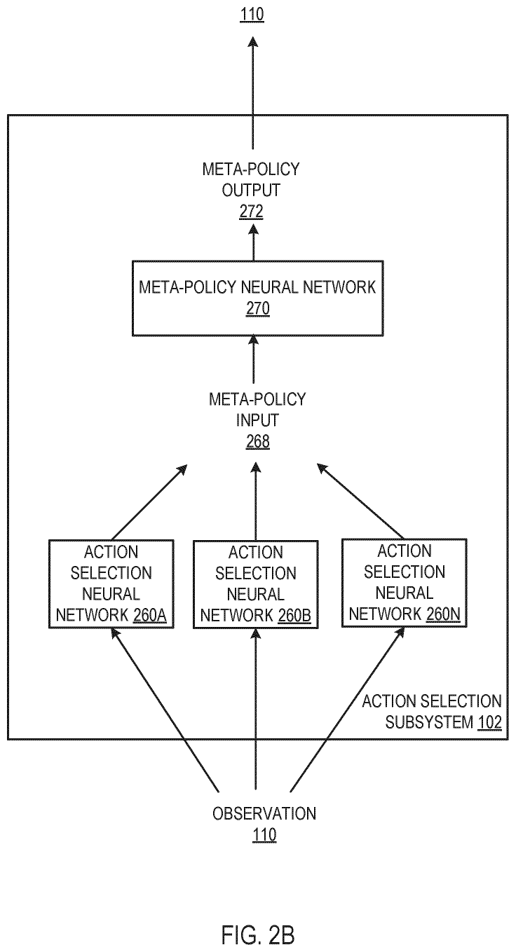

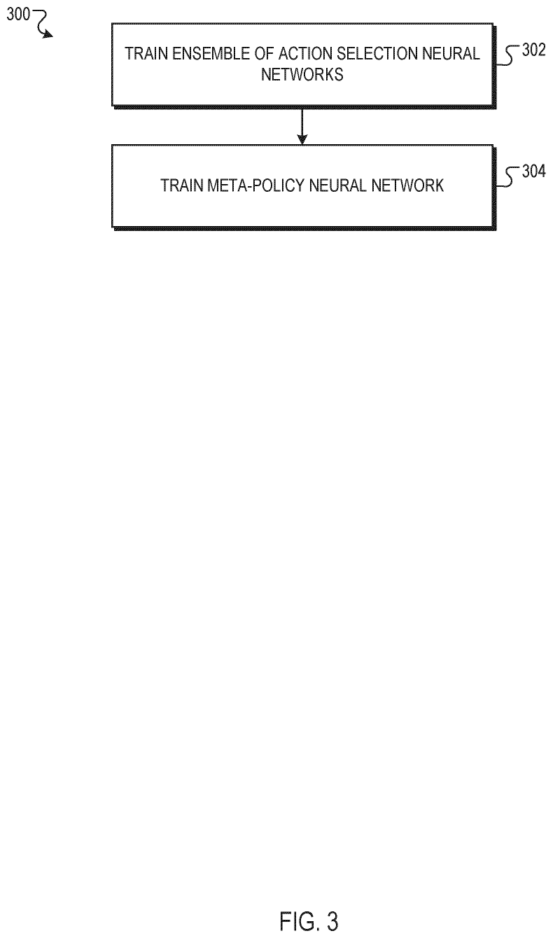

This is described in more detail below with reference to FIGS. 2 and 3.

A “risk-sensitive” action selection subsystem is one that generates outputs that are dependent on whether the action is likely to be a risky action given the current state of the environment. An action is “risky” if the expected returns resulting from selecting the action are associated with a relatively high degree of variance or other higher-order moment, i.e., relative to the other actions in the set. For example, the action selection subsystem can be “risk-seeking” and more likely to select risky actions or “risk-averse” and less likely to select risky actions.

When the action selection subsystem is risk-sensitive, the action selection subsystem can include a single action selection neural network, an ensemble of action selection neural networks, or, when the subsystem is both ambiguity-sensitive and risk-sensitive, the ensemble of action selection neural networks and the meta-policy neural network.

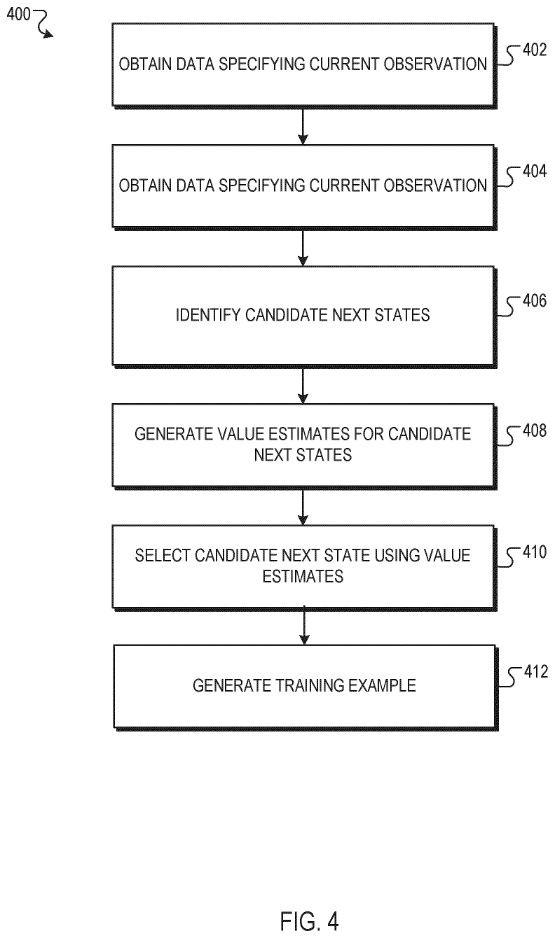

Risk-sensitivity is described in more detail below with reference to FIG. 4.

Prior to using the one or more neural networks to control the agent, a training system 190 within the system 100 or another training system can train the one or more neural networks in the action selection subsystem using reinforcement learning.

Training an ambiguity-sensitive subsystem through reinforcement learning is described below with reference to FIG. 3.

Training a risk-sensitive subsystem through reinforcement learning is described below with reference to FIG. 4.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment, to manipulate the environment, e.g., to move an object of interest to a specified location in the environment, or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing environment may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutical drug and the agent is a computer system for determining elements of the pharmaceutical drug and/or a synthetic pathway for the pharmaceutical drug. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources e.g. on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus a design of an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

FIG. 2A is a flow diagram of an example process 200 for selecting an action in an ambiguity-sensitive manner. For convenience, the process 200 will be described as being performed by a system of one or more computers located in one or more locations. For example, an action selection system, e.g., the action selection system 100 of FIG. 1, appropriately programmed in accordance with this specification, can perform the process 200.

The system can perform the process 200 at each time step during a sequence of time steps, e.g., at each time step during a task episode. The system continues performing the process 200 until termination criteria for the episode are satisfied, e.g., until the task has been successfully performed, until the environment reaches a designated termination state, or until a maximum number of time steps have elapsed during the episode.

The system receives an observation characterizing a state of the environment at the time step (step 202).

The system processes the observation using each action selection neural network in an ensemble of multiple action selection neural networks (step 204).

Each action selection neural network in the ensemble is configured to process an action selection input that includes the observation to generate a respective action selection output that defines a respective action selection policy for selecting an action from a set of actions in response to the observation. Each action selection neural network in the ensemble may have been independently trained.

In one example, the action selection output generated by a given action selection neural network may include a respective score, e.g., a respective Q-value, for each action in a fixed set.

As described above, the Q value for an action is an estimate of a “return” that would result from the agent performing the action in response to the current observation and thereafter being controlled using actions generated by the action selection neural network.

In another example, the action selection output may include a respective numerical probability value for each action in the fixed set.

As another example, when the action space is continuous the action selection output can include parameters of a probability distribution over the continuous action space.

The action selection neural networks in the ensemble can have any appropriate architecture that allows the neural networks to map an input that includes an observation to an action selection output.

For example, each action selection neural network can have the same architecture.

As one example, the action selection neural networks can each include a torso neural network, a memory neural network, and a policy head neural network.

The torso neural network is a neural network that is configured to process the observation to generate an encoded representation of the observation. For example, the torso neural network can be a convolutional neural network, a multi-layer perceptron (MLP), or a vision Transformer neural network. As another example, the torso neural network can include multiple different subnetworks for processing different types of data from the observation, e.g., a convolutional neural network or a vision Transformer for processing visual inputs and an MLP for processing lower-dimensional data.

The memory neural network is a neural network that can be, e.g., a recurrent neural network or a Transformer neural network and is configured to process the encoded representation and a current internal state to generate an updated internal state.

The policy head neural network is a neural network that can be, e.g., an MLP, and is configured to process the updated internal state to generate the action selection output.

In some examples where the action selection neural networks generate Q values, the k-th action selection neural network in the ensemble can be represented as Q_{w}_{ₖ} and the Q value generated by the k-th action selection neural network for the observation xₜ at time step t can be represented as

$${Q}_{{w}_{k}} ( {x}_{t} , {m}_{t}^{k} , {a}_{t - 1} , {r}_{t - 1} )$$

where

$${m}_{t}^{k}$$

is the internal state of the memory neural network at the time step t, aₜ₋₁ is the action performed at the preceding time step, and rₜ₋₁ is the reward received in response to the action performed at the preceding time step.

The system generates a meta-policy input from the respective action selection outputs generated by each of the action selection neural networks in the ensemble (step 206).

The system can generate the meta-policy input from the action selection outputs in any of a variety of ways. Generally, however, the meta-policy input does not include the observation.

As one example, when the respective action selection outputs each include a respective score for each action in the set of actions, e.g., a respective Q-value for each action or a respective probability for each action, the system can generate the meta-policy input by concatenating the respective scores for each of the actions in each of the respective action selection outputs.

This gives the meta-policy neural network access to the entire individual output of each neural network in the ensemble. However, this may give the meta-policy neural network information about the underlying state of the environment, instead of only providing information about how “novel” the underlying state is and, therefore, how “uncertain” the ensemble is about the effect of acting when the environment is in the state.

As another example, the system can, for each action, compute one or more moments of the respective scores for the action in the respective action selection outputs and include the one or more moments in the meta-policy input. For example, the meta-policy input can include only the one or more moments for each action, i.e., and not the observation or the scores generated by the ensemble for the actions.

A “moment” of a distribution of scores describes how the probability mass of the scores is distributed.

The one or more moments can include, e.g., the first moment, i.e., the mean, the second moment, i.e., the variance, or both. Thus, the meta-policy input can include, for each action, the mean of the scores for the action in the outputs of the ensemble, the variance of the scores for the action in the outputs of the ensemble, or both.

Thus, by, for example, including only the first and second moment of the scores in the meta-policy input, the system minimizes the leakage of state information to the meta-policy neural network while still giving the meta-policy neural network a measure of (dis) agreement between the action selection neural networks in the ensemble for a given state.

Generally, however, the meta-policy input provides a measure of ambiguity because it is derived from the action selection outputs of all of the neural networks in the ensemble. Observations where there is a large degree of disagreement between the outputs of the ensemble for one or more of the actions are likely to be ambiguous, for example, while observations where there is little disagreement between the outputs for all of the actions are likely to be unambiguous.

As a particular example, the meta-policy input can be generated by applying a function ƒ to the action selection outputs Q^{ens} generated by the action selection neural networks in the ensemble.

The system processes the meta-policy input using a meta-policy neural network to generate a meta-policy output that defines a meta-policy for selecting an action from the set of actions in response to the observation (step 208).

As described above, the meta-policy input does not include the observation, forcing the meta-policy neural network to generate the meta-policy output based on the ambiguity reflected in the action selection outputs rather than directly based on the state of the environment.

In one example, the meta-policy output may include a respective “meta” Q-value for each action in the fixed set.

In another example, the meta-policy output may include a respective “meta” numerical probability value for each action in the fixed set.

As another example, when the action space is continuous, the meta-policy output can include parameters of a “meta” probability distribution over the continuous action space.

The meta-policy neural network can have any appropriate architecture that allows the neural network to map the meta-policy input to the meta-policy output.

As one example, the meta-policy neural network can include a torso neural network, a memory neural network, and a policy head neural network.

The torso neural network is a neural network that is configured to process the meta-policy input to generate an encoded representation of the meta-policy input. For example, the torso neural network can be a convolutional neural network or a multi-layer perceptron (MLP), or a Transformer neural network.

The memory neural network is a neural network that can be, e.g., a recurrent neural network or a Transformer neural network, and is configured to process the encoded representation of the meta-policy input and a current internal state of the memory neural network to generate an updated internal state.

The policy head neural network is a neural network that can be, e.g., an MLP, and is configured to process the updated internal state to generate the meta-policy output.

In some examples, the meta-policy output at time step/generated by the meta-policy neural network πₘₑₜₐ can be represented as πₘₑₜₐ(ƒ(Q^{ens}), mₜ, aₜ₋₁, rₜ₋₁) where m, is the internal state of the memory neural network at the time step t.

The system selects an action from the set of actions using the meta-policy output (step 210).

The system can select the action in any of a variety of ways, e.g., by selecting the action with the highest “meta” Q-value or “meta” probability or by sampling an action in accordance with the “meta” probabilities or the “meta” probability distribution or by making use of a different action selection scheme.

Optionally, the system then causes the agent to perform the selected action, e.g., by directly controlling the agent to perform the selected action or by transmitting an instruction or other data specifying the selected action to a control system for the agent.

Thus, by making use of the meta-policy neural network to select the action from the outputs of the ensemble rather than directly using the ensemble, the system controls the agent in an “ambiguity-sensitive” manner. That is, the meta-policy neural network has learned, during the training of the meta-policy neural network, to consider the impact the ambiguity of the current state (as reflected by the action selection outputs of the ensemble) on future rewards that are received in response to actions selected in the current state.

In some implementations, the action selection neural networks in the ensemble have been trained on training data that includes only non-ambiguous training examples. In other words, while some of the observations in the training examples may have been determined to be risky, i.e., so that certain actions can have relatively large variance in their returns, the observations include enough information to accurately determine the distribution of possible returns for each of the actions.

That is, the action selection neural networks have been trained on training data from task episodes that have been determined to not include ambiguous observations. For example, the system can receive data designating certain task episodes as ambiguous, i.e., because it has been determined that certain states of the environment that are likely to be encountered during the task episodes are ambiguous with respect to the impact of one or more of the actions performed in the state, and refrain from using any training data generated during those task episodes to train the action selection neural network.

That is, the training data has been partitioned into ambiguous training examples and non-ambiguous training examples and only the non-ambiguous training examples have been used to train the ensemble.

After the training, the meta-policy neural network has been trained on both ambiguous and non-ambiguous training examples. Whether the meta-policy neural network becomes ambiguity-seeking or ambiguity-averse is dependent on the rewards in the ambiguous training examples.

This training is described below with reference to FIG. 3.

FIG. 2B is a diagram of the action selection subsystem 102 when the action selection subsystem 102 is ambiguity-sensitive.

As described above, the action selection subsystem 102 includes an ensemble of action selection neural networks 260A-260N and a meta-policy neural network 270.

When the subsystem 102 receives the observation 110, the subsystem 102 processes the observation using each action selection neural network 260A-N in the ensemble.

Each action selection neural network 260A-N in the ensemble has been independently trained and is configured to process an action selection input that includes the observation 110 to generate a respective action selection output that defines a respective action selection policy for selecting an action from the set of actions in response to the observation 110.

As described above, each action selection neural network can have the same architecture, e.g., with each including a torso neural network, a memory neural network, and a policy head neural network.

The subsystem 102 then generates a meta-policy input 268 from the respective action selection outputs generated by each of the action selection neural networks 260A-N in the ensemble

For example, to limit the amount of information about the underlying state of the environment that is received by the meta-policy neural network 270, the subsystem 102 can include one or more moments of the action selection outputs for each action in the meta-policy input 268, i.e., without including the observation or the scores generated by the ensemble for the actions.

Thus, by, for example, including only the first and second moment of the scores in the meta-policy input 268, the subsystem 102 minimizes the leakage of state information to the meta-policy neural network 270 while still giving the meta-policy neural network 270 a measure of (dis) agreement between the action selection neural networks in the ensemble for a given state.

The subsystem 102 processes the meta-policy input 268 using the meta-policy neural network 270 to generate a meta-policy output 272 that defines a meta-policy for selecting an action from the set of actions in response to the observation 110.

The subsystem 102 then selects the action 110 using the meta-policy output 272.

FIG. 3 is a flow diagram of an example process 300 for training the ensemble of action selection neural networks and the meta-policy neural network. For convenience, the process 300 will be described as being performed by a system of one or more computers located in one or more locations. For example, an action selection system, e.g., the action selection system 100 of FIG. 1, appropriately programmed in accordance with this specification, can perform the process 300.

The system trains the ensemble of action selection neural networks on a first set of training data through reinforcement learning (step 302).

As described above, each of the action selection neural networks can have the same architecture, but different parameter values. To achieve this, the system can initialize the parameter values for each action selection neural network differently, e.g., by setting each to a different random initialization.

The system can train the action selection neural networks in any of a variety of ways. For example, when the action selection neural networks generate Q values for the actions, the system can train the neural networks in the ensemble through an appropriate variant of Q-learning, e.g., an off-policy or off-line Q learning variant.

As described above, in some implementations, the system trains the ensemble on training data that includes only non-ambiguous training examples. In other words, while some of the observations in the training examples may have been determined to be risky, i.e., so that certain actions can have relatively large variance in their returns, the observations include enough information to accurately determine the distribution of possible returns for each of the actions.

After training the ensemble, the system trains the meta-policy neural network on second training data while holding the ensemble fixed (step 304). For example, the system can train the meta-policy neural network using any appropriate reinforcement learning technique on training data that includes both ambiguous data and non-ambiguous data, e.g., risky data.

For example, when the meta-policy neural network generates a probability distribution or an output that defines a probability distribution, the system can train the meta-policy neural network using a policy gradient reinforcement technique or a policy improvement technique. As another example, when the meta-policy neural network generates Q-values, the system can train the meta-policy neural network using a Q-learning technique.

As a result of being trained through reinforcement learning on both of these types of data, the meta-policy neural network becomes ambiguity-sensitive. That is, because the ensemble has already been trained, the meta-policy input for any given observation will indicate whether the observation is ambiguous, e.g., because there will be a large discrepancy in the outputs of the action selection neural networks in the ensemble for certain ambiguous actions.

As a simplified example, if rewards for ambiguous actions are higher than rewards for non-ambiguous actions during the training, the meta-policy neural network will be more likely to select ambiguous actions and will become ambiguity-seeking. Conversely, if rewards for ambiguous actions are lower than rewards for non-ambiguous actions during the training, the meta-policy neural network will be less likely to select ambiguous actions and will become ambiguity-averse.

In some implementations, the system then terminates the training.

In some other implementations, the system then alternates between training the ensemble and training the meta-policy neural network. For example, after the initial round of training of the neural networks, the system can identify additional training data that is non-ambiguous, e.g., based on a measure of disagreement between outputs generated by the ensemble, and then train the ensemble further on that training data. Optionally, the system can then further fine-tune the meta-policy neural network.

As described above, in addition to or instead of being ambiguity-sensitive, the system can also control the agent to be risk-sensitive.

That is, the system can also train an action selection neural network to become “risk-sensitive” after training.

For example, the action selection neural network can be one of the neural networks in the ensemble described above or can be a different action selection neural network that is not part of an ensemble or that is part of a neural network system that is not “ambiguity-sensitive.”

The action selection neural network can, e.g., have the architecture described above with reference to FIG. 2A.

In particular, the system can train an action selection neural network to be “risk-sensitive” by appropriately generating training data for the action selection neural network and then training the action selection neural network on the training data through reinforcement learning.

For example, the system can repeatedly alternate between generating training data and training the action selection neural network. As another example, the system can generate training data using one or more actors, store the generated training data in a replay memory, and sample training data from the replay memory for use in training the neural network.

FIG. 4 is a flow diagram of an example process 400 for generating a training example to be included in training data for a risk-sensitive action selection neural network. For convenience, the process 400 will be described as being performed by a system of one or more computers located in one or more locations. For example, an action selection system, e.g., the action selection system 100 of FIG. 1, appropriately programmed in accordance with this specification, can perform the process 400.

The system can perform the process 400 at each time step within a task episode that was performed during the training or can perform the process 400 for only a subset of the time steps within the task episode, e.g., because the system refrains from modifying the transition probabilities for the other time steps in the task episode.

The system obtains data specifying a current observation xₜ characterizing a current state of the environment (step 402) and a current action aₜ performed by the agent in response to the current observation xₜ characterizing a current state of the environment (step 404).

In some implementations, e.g., when the system is performing the training on-line, the system can identify the current action by processing the current observation using the action selection neural network, using the action selection output to select the current action, and then causing the agent to perform the current action.

In some other implementations, e.g., when the system is performing the training off-line, the system can identify the current action from an initial set of training data that has already been generated by controlling the agent.

The system identifies a plurality of candidate next states that the environment transitions into as a result of the agent performing the current action in response to the current observation (step 406). That is, the system can identify N+1 observations characterizing candidate next states of the environment, where each observation is represented as

$${x}_{t + 1}^{k} ,$$

where k ranges from 0 to N.

In some implementations, when the action selection neural network is being trained in simulation, the system can identify the candidate next states by sampling a fixed number of candidate next states from the simulation. That is, the system can cause the simulation to draw multiple samples from an underlying transition probability distribution maintained by the simulation over next states of the environment given the current state and the current action.

In some other implementations, when the system is analyzing an initial set of training data, the system can search the initial set of training data for training examples where performing the current action in response to the current observation resulted in the environment transitioning into a given state and use all of the resulting states as the candidate next states or use a threshold number of most frequently occurring resulting states as the candidate next states.

The system generates, using the neural network, a respective value estimate

$$V ( {x}_{t + 1}^{k} )$$

for each of the candidate next states (step 408).

For example, when the action selection neural network generates Q values, the system can generate a respective value estimate for each of the candidate next states by, for each candidate next state k, processing an input that includes an observation

$${x}_{t + 1}^{k}$$

characterizing the candidate next state using the neural network to generate a respective Q value for each action in a set of actions. The system can then select, as the respective value estimate for the candidate next state, the highest Q value of the respective Q values for the actions in the set.

The system then selects one of the candidate next states based on the respective value estimates

$$V ( {x}_{t + 1}^{k} )$$

(step 410).

Based on the way that the system selects the candidate next states, the system can cause the neural network to be either risk-seeking or risk-averse.

For example, the system can generate, based on the respective value estimates, a respective probability for each candidate next states and then select one of the candidate next states based on the respective probabilities. For example, the system can sample a candidate next state in accordance with the respective probabilities.

In some implementations, the system generates the probabilities such that respective probabilities for candidate next states that have higher value estimates are higher than respective probabilities for candidate next states that have lower value estimates.

For example, the system can apply a softmax with a specified temperature over the respective value estimates to generate the respective probabilities. That is, in this example, the system generates probabilities for the N+1 states that satisfy:

$${softmax}_{k ∈ \{ 0 , … N \}} ( V ( {x}_{t + 1}^{k} ) )$$

Selecting the candidate next states in this manner will generally cause the action selection neural network to become risk-seeking, e.g., because selecting actions that have multiple different possible next states is more likely to yield returns that are on the higher end of those that are possible for the candidate next states.

In some other implementations, the respective probabilities for candidate next states that have lower value estimates are higher than respective probabilities for candidate next states that have higher value estimates. For example, the system can apply a softmin with a specified temperature over the respective value estimates to generate the respective probabilities. That is, in this example, the system generates probabilities for the N+1 states that satisfy:

$${softmin}_{k ∈ \{ 0 , … N \}} ( V ( {x}_{t + 1}^{k} ) )$$

Selecting the candidate next states in this manner will generally cause the action selection neural network to become risk-averse, e.g., because selecting actions that have multiple different possible next states is more likely to yield returns that are on the lower end of those that are possible for the candidate next states.

The system can then generate a training example that identifies (i) the current observation, (ii) the current action, and (iii) a next observation characterizing the selected candidate next states (step 412). In some implementations, the system also identifies a current reward that is received in response to the agent performing the current action and also includes the current reward in the training example.

After the training example is generated, the system can train the neural network on the generated training data that includes the training example through reinforcement learning, e.g., using any of the reinforcement learning techniques described above.

Thus, during training, the system modifies the underlying transition distribution of the environment to cause the action selection neural network to become risk-sensitive. For example, by modifying the transition distribution to favor more “optimistic” outputs for risky actions, the action selection neural network will favor risky actions and become risk-seeking. As another example, by modifying the transition distribution to favor more “pessimistic” outputs for risky actions, the action selection neural network will avoid risky actions and become risk-averse.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method for controlling an agent interacting with an environment, the method comprising:
obtaining an observation;
processing the observation using each action selection neural network in an ensemble of multiple action selection neural networks, each action selection neural network in the ensemble being configured to process an action selection input comprising the observation to generate a respective action selection output that defines a respective action selection policy for selecting an action from a set of actions in response to the observation;
generating a meta-policy input from the respective action selection outputs generated by each of the action selection neural networks in the ensemble;
processing the meta-policy input using a meta-policy neural network to generate a meta-policy output that defines a meta-policy for selecting an action from the set of actions in response to the observation;
selecting an action from the set of actions using the meta-policy output; and
causing the agent to perform the selected action.

2. The method of claim 1, wherein the meta-policy input does not include the observation.

3. The method of claim 1, wherein the respective action selection outputs each include a respective score for each action in the set of actions.

4. The method of claim 3, wherein the respective scores are Q-values.

5. The method of claim 3, wherein generating a meta-policy input from the respective action selection outputs generated by each of the action selection neural networks in the ensemble comprises:
concatenating the respective scores for each of the actions in each of the respective action selection outputs.

6. The method of claim 3, wherein generating a meta-policy input from the respective action selection outputs generated by each of the action selection neural networks in the ensemble comprises:
for each action:
computing one or more moments of the respective scores for the action in the respective action selection outputs; and
including the one or more moments in the meta-policy input.

7. The method of claim 6, wherein the one or more moments comprise a first moment and a second moment of the respective scores for the action in the respective action selection outputs.

8. The method of claim 6, wherein the meta-policy input includes only the one or more moments for each of the actions.

9. The method of claim 1 wherein the meta-policy neural network comprises:
a torso neural network configured to process the meta-policy input to generate an encoded representation;
a recurrent neural network configured to process the encoded representation and a current internal state to generate an updated internal state; and
a policy head neural network configured to process the updated internal state to generate the meta-policy output.

10. The method of claim 1, wherein the meta-policy neural network has been trained on first training data that includes (i) ambiguous training examples and (ii) non-ambiguous training examples.

11. The method of claim 10, wherein the action selection neural networks in the ensemble have been trained on second training data that includes only non-ambiguous training examples.

12. The method of claim 1, wherein the agent is a mechanical agent and the environment is a real-world environment.

13. The method of claim 12, wherein the agent is a robot.

14. The method of claim 1, wherein the environment is a real-world environment of a service facility comprising a plurality of items of electronic equipment and the agent is an electronic agent configured to control operation of the service facility.

15. The method of claim 1, wherein the environment is a real-world manufacturing environment for manufacturing a product and the agent comprises an electronic agent configured to control a manufacturing unit or a machine that operates to manufacture the product.

16. The method of claim 1, wherein, during training, the environment is a simulated environment and the agent is a simulated agent.

17. The method of claim 16, further comprising:
after the training, deploying the ensemble and the meta-policy neural network for use in controlling a real-world agent interacting with a real-world environment.

18. The method of claim 16, further comprising:
after the training, controlling a real-world agent interacting with a real-world environment using the ensemble and the meta-policy neural network.

19. A system comprising:
one or more computers; and
one or more storage devices communicatively coupled to the one or more computers, wherein the one or more storage devices store instructions that, when executed by the one or more computers, cause the one or more computers to perform operations comprising:
obtaining an observation;
processing the observation using each action selection neural network in an ensemble of multiple action selection neural networks, each action selection neural network in the ensemble being configured to process an action selection input comprising the observation to generate a respective action selection output that defines a respective action selection policy for selecting an action from a set of actions in response to the observation;
generating a meta-policy input from the respective action selection outputs generated by each of the action selection neural networks in the ensemble;
processing the meta-policy input using a meta-policy neural network to generate a meta-policy output that defines a meta-policy for selecting an action from the set of actions in response to the observation;
selecting an action from the set of actions using the meta-policy output; and
causing the agent to perform the selected action.

20. One or more non-transitory computer storage media storing instructions that when executed by one or more computers cause the one or more computers to perform the operations comprising:
obtaining an observation;
processing the observation using each action selection neural network in an ensemble of multiple action selection neural networks, each action selection neural network in the ensemble being configured to process an action selection input comprising the observation to generate a respective action selection output that defines a respective action selection policy for selecting an action from a set of actions in response to the observation;
generating a meta-policy input from the respective action selection outputs generated by each of the action selection neural networks in the ensemble;
processing the meta-policy input using a meta-policy neural network to generate a meta-policy output that defines a meta-policy for selecting an action from the set of actions in response to the observation;
selecting an action from the set of actions using the meta-policy output; and
causing the agent to perform the selected action.
